(19) United States
(12) Patent Application Publication
(10) Pub. No.: US 2013/0087556 A1
(43) Pub. Date: Apr. 11, 2013

(54) Method for Preparing a Multi-Texture Food Product Using Microwave Interactive Packaging

(71) Applicants: Kathyrn Marie Birchmeier, Glenview, IL (US); Anna Elizabeth Olsen, Chicago, IL (US)

(72) Inventors: Kathyrn Marie Birchmeier, Glenview, IL (US); Anna Elizabeth Olsen, Chicago, IL (US)

(21) Appl. No.: 13/628,190

(22) Filed: Sep. 27, 2012

Related U.S. Application Data
(60) Provisional application No. 61/543,571, filed on Oct. 5, 2011.

(51) Int. Cl. H05B 6/80

(52) U.S. Cl. 219/725

(57) ABSTRACT

A method for preparing a multi-texture food product from a dehydrated, shelf-stable dry food product using a microwave interactive package. The method comprises a two-part process for preparing the multi-texture food product resulting in a product having oven-baked attributes, such as browning and/or a dried and crispy outer texture, upon cooking in a microwave oven. The first step rehydrates the dehydrated food upon water addition and heating in the microwave while in the microwave interactive package. The second step comprises adding a sauce component to the rehydrated food and heating a second time in the microwave while in the microwave interactive package. The microwave interactive package contains a susceptor in at least a portion of its sidewall, which interacts with the adjacent food product to provide the desired oven-baked features.

### CROSS-REFERENCE TO RELATED APPLICATION

This application claims priority from U.S. Provisional Application Ser. No. 61/543,571, filed Oct. 5, 2011, the contents of which are incorporated herein by reference in their entirety.

### FIELD

A method for preparing a multi-texture food product using microwave interactive package is provided and, in particular, for preparing a multi-texture food product using a dehydrated, shelf-stable dry food product.

### BACKGROUND

Prior systems are known that include susceptors or shields incorporated with the container to assist in microwave cooking. However, commercial products that are shelf stable and require water addition prior to microwave cooking tend to utilize plastic containers that are not interactive with microwave energy, i.e., without any type of susceptors or shields for cooking. The temperatures associated with the susceptors or shields can be incompatible with the plastic. A microwave susceptor is not provided with a shelf stable food package that requires water, such as dried pasta and water, because it would have little or no effect upon the water being cooked or boiled therein.

One example of a microwaveable, shelf-stable product packaged in a plastic container is a dehydrated pasta. A separate pack containing ingredients used for making a sauce for the pasta can be included. Upon microwaving the dehydrated pasta in water in order to rehydrate the pasta and then subsequently mixing in the ingredients for making the sauce, a food product results that is generally homogeneous in taste and texture and resembles more of a steamed or stovetop prepared pasta and sauce than an oven-baked pasta and sauce. An oven-baked pasta and sauce can be associated with having certain oven baked cues, such as color changes or browning of the food product at its edges and/ or surface and with having a dual texture such that the product may be crispier or dried in exposed external areas or exterior areas while remaining creamy on the inside.

Commercial products utilizing shielding and susceptors in packaging are primarily found in the frozen food category and to a lesser extent the refrigerated food category. The frozen or refrigerated food has a preparation process and heating requirements which are very different from a shelf stable product to which water is added and, in particular, such frozen and refrigerated foods do not require water addition. Susceptors are typically used to brown and crisp starch and dough based products such as pot pies, French fries, and pizzas. Susceptors are used to focus the microwave energy to specific locations in the product that are in contact with the susceptor to create specific heating conditions. In particular, susceptors are used to absorb microwave energy and tend to provide localized heat to the product adjacent the susceptor while shields tend to block or reflect microwave energy and reduce or minimize the heat provided to the product adjacent the shielded area. Typically, susceptors are placed adjacent one component of the food, such as the food to be browned, without contacting the additional food components to ensure the other foods do not brown.

The shelf stable food product that requires water addition prior to microwave cooking can undergo significant changes upon heating in moisture, volume, height of the product, and surface area during microwave cooking versus a standard frozen or refrigerated food product that is heated. The existing commercial packages and associated susceptor and shielding patterns provided therewith for frozen or refrigerated food products are not optimal for creating oven-baked attributes in a shelf stable food product that requires water addition nor would it be obvious to provide a susceptor or shield for microwave cooking a shelf stable product to which water is added.

Many shelf stable products that require accurate water addition are packaged in containers made from polymer materials in which a line and/or text indicator of a fill line can be easily embossed into the plastic polymer material to indicate the fill location of the water. Other methods of including a fill line indicator have included creating a geometric feature in the container at the fill location, such as a step or indentation in the sidewall of the container or by molding/printing a fill line indicator on the outside of the container when the container is made of a clear material and the indicator line can be viewed from the inside of the container, through the sidewall.

For paperboard packaging and the like, specifically pressed paperboard packaging, achieving a defined fill line in the sidewall of the package using a geometric indicator, such as a step or indentation is hindered by limitations on making small radii and angles in a paperboard container. This is in contrast to the defined geometric fill line that is commonly used in polymer forming processes to define a very visually crisp and clear fill line location as a step. A large step may also cause issues with water addition accuracy, as there will be a wider “target” for the consumer to use when adjusting the amount of water in the package. The paper material used to make a paperboard container does not flow like plastic polymer material, and contains folds in the sidewall, so it is not feasible to get clear line and text using the embossing method used with polymer materials. Since the paper material is not clear, markings made on the outside of the container cannot be viewed from the inside of the container.

### SUMMARY

A method and a food kit that utilize a microwave interactive package format combined with a microwave preparation method for achieving conventional oven-baked product attributes with a dehydrated, shelf stable product. The method comprises a two-part process for preparing the shelf-stable, dehydrated food product with oven-baked attributes in the final product provided by heating in a microwave in a microwave interactive package. The microwave interactive package, such as a bowl or other container, has a microwave absorbing region at least in a portion of the package. The dehydrated, shelf-stable food is first combined with a predetermined amount of water and together with the microwave interactive package is heated in the microwave for a set time to at least partially hydrate the food product. The second step adds a second food component to the at least partially hydrated food product while still in the microwave interactive package, the second food component and the at least partially hydrated food are mixed and the microwave interactive package is placed in the microwave for a second heating step for a second set time. It is during this second heating step that the food product begins to at least partially change color, i.e., “brown”, and to at least partially change in texture to provide a multi-texture food item.

The microwave interactive package includes regions of the package that absorb microwave energy to a greater extent compared to adjacent regions without the interactive component during microwave heating. These specific areas of the package that contain an interactive portion that absorb more microwave energy, such as a susceptor, can alter the microwave energy exposure and the resulting product temperature in the areas adjacent to the interactive regions, thus modifying the color and/or texture of the product while not affecting the water and rehydration of the product when cooked in the same container.

Conventional oven cooking provides a product that has a color change, such as browning along the product edges and upper surfaces, as well as a texture change where the outside is typically drier and crispier while the inside remains creamy. Standard microwave cooking usually does not produce the same results, in part due to shorter cook times and lower temperatures achieved in the microwave. The use of the microwave interactive container allows for the convenience of using the same package throughout the preparation process, without having to transfer the food product to different containers at each preparation step. The same container can be used to prepare and hydrate the dehydrated food by water addition and microwave heating as well as microwave heating the hydrated food and a sauce to result in a final product that has more conventional oven baked attributes as compared to rehydrating of pasta in a plastic container lacking microwave interactive areas.

Additionally, the appropriate amount of water can be added by indicating the level to which to fill the water by a fill level or line indicator. The fill line indicator can be designated in the paper material of the container by either using a pattern in the susceptor material or creating a pattern or line with the susceptor itself. This ensures that the proper amount of water is added to the dehydrated food to rehydrate as well as providing for the correct residual amount of water after hydration where the microwave cook time plus water amount added can be optimized to provide for these two details.

Alternatively, the two-step preparation process of the multi-texture product can be performed in a single preparation step where the second food component, such as a sauce, can be added to the dehydrated food together with the predetermined amount of water and mixed in the microwave interactive bowl. This entire mixture can then be heated in the microwave in a single heating step that can hydrate and brown the mixture in the same heating step.

### BRIEF DESCRIPTION OF THE DRAWINGS

FIG. 1 is a perspective view of a microwave interactive package;

FIG. 2 is a perspective view of the package of FIG. 1 being opened;

FIG. 3 is a cross-sectional view of the package of FIG. 2 containing water;

FIG. 4 is a side view of the package of FIG. 3 being placed in a microwave oven;

FIG. 5 is a cross-sectional view of the package of FIG. 3 after heating in the microwave oven and being combined with a second food component;

FIG. 5A is a cross-sectional view of the area identified in FIG. 5;

FIG. 6 is a side view of the package of FIG. 5 being placed in a microwave oven;

FIG. 7 is a cross-sectional view of the package of FIG. 6 after heating in the microwave oven;

FIG. 8 is a flow chart of an exemplary process for preparing a multi-texture food product with sauce;

FIG. 9 is a perspective view of a second embodiment of a microwave interactive package with a fill level indicator;

FIG. 10 is a perspective view of a third embodiment of a microwave interactive package with a fill level indicator;

FIG. 11 is a perspective view of a fourth embodiment of a microwave interactive package with a fill level indicator; and

FIG. 12 is a perspective view of a fifth embodiment of a microwave interactive package with a fill level indicator.

### DETAILED DESCRIPTION

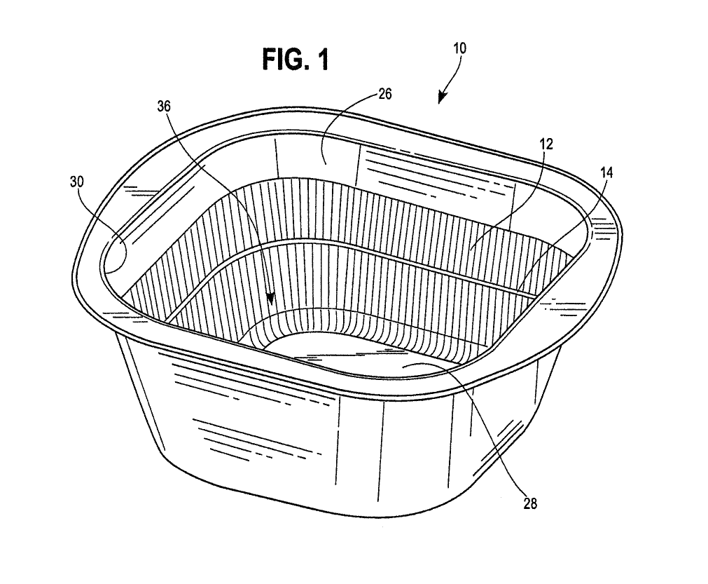

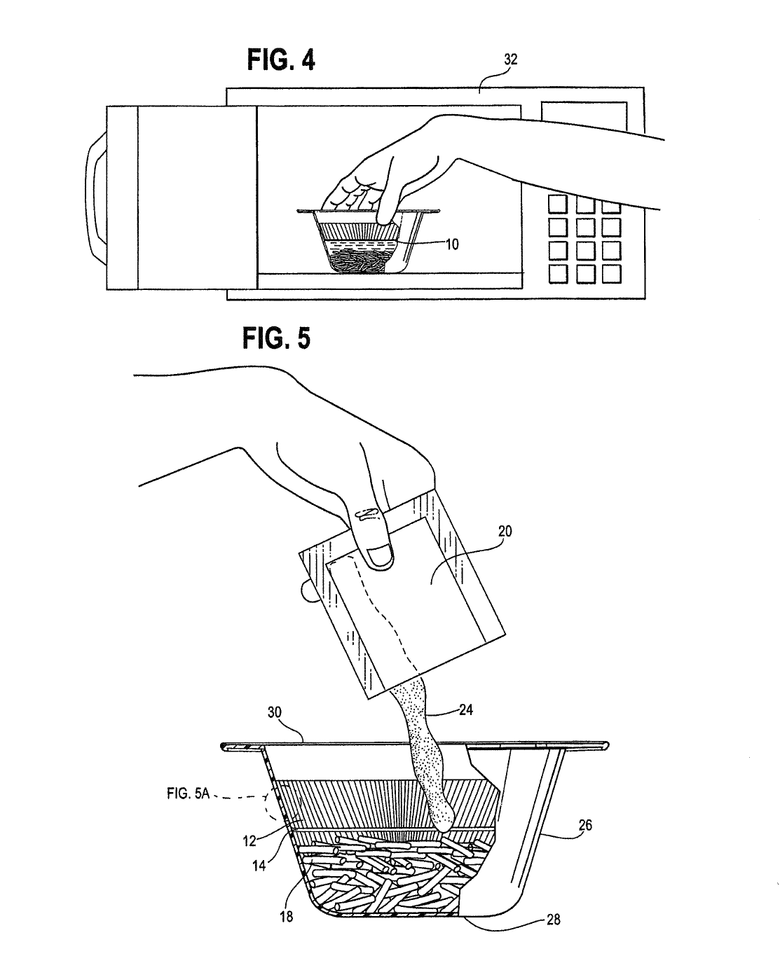

A method and food kit for preparing a shelf stable dry product in a microwave interactive package, such as a bowl or other similar container, that results in a color change and/or in a multi-texture food product, so that the product has more of an oven-baked quality and appearance is described herein and provided in FIGS. 1-12. The method and food kit comprises a two-step process involving microwave heating the shelf stable, dehydrated food product and water to rehydrate the product in a container or bowl having a susceptor followed by an additional microwave heating step after addition of a second food component to brown the product and achieve oven-baked cues. The two-step heating process that takes place in the susceptor-containing container is provided such that the susceptor does not impact the cooking or hydration of the dehydrated product in water while still being able to brown and/or crisp portions of the final product. Alternatively, a single step preparation method can be provided where the second food component is added at the beginning together with the water and the dehydrated pasta is rehydrated and browned all in the same cooking step in the microwave.

It should be understood that where the “browning” of the product is mentioned, this refers to the darkening in color of the food product and not that the actual color of the product is brown. The actual color of the “browned” food product may be any color and can vary, for example, from a brown color to a dark orange color and so on. Additionally, wherever hydration or rehydration of the dehydrated product is mentioned this should be understood to imply that the product can be either partially hydrated or fully hydrated.

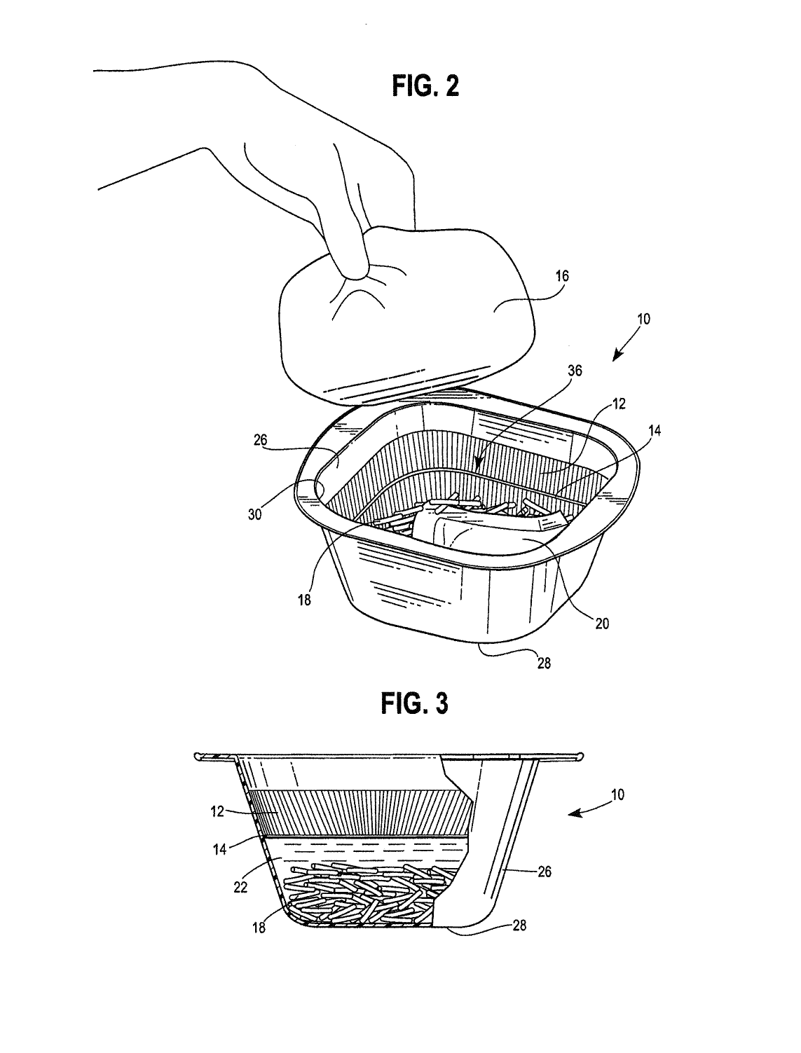

Referring to FIGS. 1 and 2, a container 10 is provided having a susceptor 12 attached to or integral with the walls of the container 10. The food product included in the susceptor-containing package can be a dehydrated, shelf-stable food product, such as dry pasta noodles 18, which is rehydrated by adding water 22 and heating in a microwave 32 for a first period of time. After rehydration of the shelf-stable product, a sauce 24 or additional food component can then be added and mixed into the product and reheated a second time in the microwave 32 for a second period of time. The susceptor 12 is placed in regions of the container 10 where browning of the food product and a drier texture of the product are desired to occur. It is during the second heating step that the browning of the food product occurs in these areas adjacent the susceptor 12. The browning occurs during the second step and not during the first step due to the fact that the second additional food component is not present during the first heating step and because water is present, which is minimally affected by the susceptor or not at all. The change in color and texture can occur when the majority of the water 22 has been cooked off at least partially hydrating the dehydrated product and the additional food component, such as a sauce, has been added to the rehydrated product initiating browning upon exposure to heat and from cooking in a susceptor.

In an effort to replicate the darker, drier edges and top surface of a product that is baked in a conventional oven, the susceptor placement on the container 10 can be at least in a portion of the sidewalls 26 of the container 10 and, in particular, the susceptor 12 can extend from a portion of the base 28 or bottom wall of the container 10 to at least half way up the sidewall 26 or to a location that is near the surface level of the product within the container 10. In one aspect, the susceptor 12 extends from the intersection with the base 28 up to a position that is just above the top surface 34 of the product being cooked within the container 10. In another aspect, the susceptor 12 can extend partially along the base 28 itself and then upwards along the sidewall 26 to a desired location, such as just at or above the top surface 34 of the product within the container 10, as shown in FIG. 1. It is understood that the height of the susceptor 12 extending along the sidewall 26 of the container 10 can extend more or less than is shown in the FIGURES herein. For instance, the susceptor 12 can extend along the entire sidewall 26 from the intersection with the base 28 up to the container opening 30 at the upper portion of the sidewall 26 opposite the base 28, or any variation in between. However, it is preferred that at least a portion of the base wall 28 is not covered by the susceptor 12 and, in particular, that a majority (e.g., more than 50%, including 60%, 70%, 80% and 90% or more) of the base wall 28 is free of the susceptor, as illustrated in FIG. 1. In another aspect, the upper portion of the susceptor is spaced from the opening 30 of the container 10.

The susceptor 12 can, upon heating in the microwave 32, provide temperatures which can slightly dry the product, particularly in regions adjacent to the susceptor, to produce a crispier product, and which can also produce browning of a portion of the product. These results can be obtained by both direct conduction of heat in the microwave as well as exposure to radiant heat from the microwave. In one aspect, during microwave cooking the susceptor is converting microwave energy to sensible heat which is then conducted and radiated from the susceptor to the food. The high temperatures that are present at the product/ susceptor interface is one of the drivers of the browning of the food product. Additionally, the microwave energy can also be absorbed by molecules in the food, which can cause movement of the molecules resulting in friction and heat dissipation into the food. This can result in moisture evaporation to occur in the food, which is an enabler of the browning.

In order to brown the product, a Maillard reaction can occur which, through activation by heat, a chemical reaction occurs that results in nonenzymatic browning. In particular, it can be the combination of application of heat to the product and a component in the food product itself, such as the sauce 24 or additional food component added, that is receptive to browning and reacts to cause the product to brown.

Additionally, if there is too much browning in certain areas of the food product, a patterned susceptor can be provided to reduce the microwave energy and temperature transmitted to the product. A patterned susceptor can be provided by creating a pattern within the susceptor 12 itself where there can be alternating sections of a susceptor and no susceptor along the walls of the container 10. In one aspect, the pattern can be provided by first placing a susceptor 12 onto a film and afterward removing sections of the susceptor 12 from the areas where no susceptor is desired, such as by deactivating those sections. The susceptor-film combination can then be laminated onto a blank that is formed into a container 10, such that the patterned susceptor is in the walls of the container 10. Alternatively, a susceptor already having the desired pattern can also be provided and bonded to the film, such that certain sections of the film are not covered with the susceptor, and then the susceptor-film can be laminated onto a blank that is formed into the container. This is done by known techniques in the art for susceptor application to containers and for pattern creation by removing parts of the susceptor in order to form a pattern.

In one aspect, if browning and heat generation is desired above the surface of the product, but it is not desired to overcook any residual amount of product present on the sidewall, then a patterned susceptor can be utilized on the sidewall in areas above the top surface level of the product. In another aspect, where it is desired to have the outer edges result in a drier crispy product while browning the top surface, an embodiment where the susceptor extends from the intersection of the base 28 with the sidewall 26 up to the top surface of the product or just beyond can provide the desired result. Alternatively, the susceptor 12 can be provided in a similar orientation but where it partially wraps around the base 28, extending just slightly past the edges or rounded corners of the base 28. In order to maintain a creaminess in the center of the product and along the bottom surface, the majority of the base wall 28 can remain free of the susceptor.

In another alternative embodiment, a lid (not shown) can be provided on the container of FIG. 1, which can be kept in place over the container opening 30 while the product is being heated in the microwave. The lid can provide several functions, one of which is to retain heat and/ or steam in the container 10 upon heating without letting it escape into the interior of the microwave. The lid may also optionally contain one or more vent holes to allow some but not all of the steam to escape from the interior 36 of the container 10 into the interior of the microwave as too much moisture present in the food can inhibit the browning process of the food product within the container 10. Another function of the lid is to provide another surface that can contain a susceptor. The lid can be provided with a susceptor material in all or part of the lid, i.e., either a full or patterned susceptor, which can provide additional browning and drying of the top surface 34 of the product. The susceptor in the lid can provide additional heat to the top surface 34 of the product where the lid can be placed in close proximity to the product but not in direct contact to the product within the container 10.

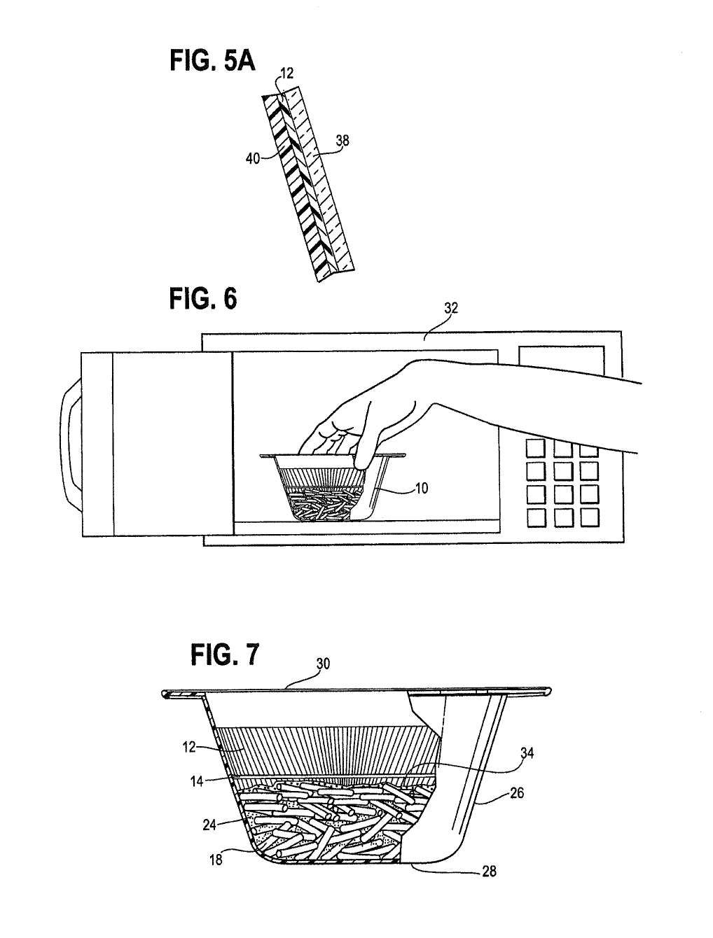

The container 10 comprising a patterned or full susceptor can be produced using different techniques. One such technique can provide a two or more layer film or material for the container 10 where the susceptor material is positioned between the two or more layers, as a middle or central layer. In one aspect, a container 10 can comprise a three layer bowl having an outer paperboard layer 40, that has a middle or central layer of susceptor material 12, such as in the form of an aluminum material, which is deposited onto a film layer, such as polyethylene terephthalate. The film layer containing the susceptor material is then laminated to the paperboard material, such that the film layer becomes the inner layer 38 that is in contact with the food product, as illustrated in FIG. 5A. This three-layer component is then press-formed into a container 10. Optionally, if a patterned susceptor is desired, then portions of the susceptor material 12 can be removed to create the desired combination of susceptor-no susceptor portions. In another aspect, where the inner layer 38 (e.g., polyethylene terephthalate layer) is a clear or relatively transparent film, the aluminum susceptor material 12 may be visible through the inner layer 38 as a gray or other different colored layer. Other materials or other processes may also be incorporated and are not limited to that disclosed herein.

The method of making and preparing the dehydrated, shelf stable food product such that it results in a fully cooked product having oven-baked attributes is disclosed herein and in FIGS. 2-7. The oven-baked attributes that are desirable include both having an appearance of the final product that looks “oven-baked,” such that it looks like it was baked in the oven resulting in browning, as well as having an oven-baked texture of the product, such as having a dual texture. The oven-baked appearance comprises the color change that can result upon heating in the microwave such that browning of the food product along the product edges and surfaces is observed. The dual texture that is desired can comprise a crispier or drier outer surface having a creamy inner surface.

The product components that are initially packaged can include a dry, dehydrated shelf stable food product, such as a dry pasta, and segregated food components packaged in one or more pouches that are to be added and mixed into the dehydrated product before and/or after initial heating of the dry product. The product components are packaged in the container having microwave interactive regions, e.g., a susceptor and/or shield, so that they can be later cooked/heated in the container having microwave interactive regions.

The initially sealed microwave interactive package is opened and any food pouches are removed while the dry pasta product 18 remains inside of the container 10. The dry product is rehydrated directly in the microwave interactive package by addition of a predetermined amount of water which is then heated in a microwave. The predetermined quantity of water is added to the dry product directly into the microwave interactive container and is subsequently heated in the microwave for an appropriate amount of time to provide enough heat to cook and hydrate the dry product.

The water amount that is needed can be determined by an interior fill level indicator 14 in the sidewall 26 of the package 10 or can be premeasured by the consumer. It is preferable to provide a fill line indicator 14 in the sidewall 26 of the package 10 along the inner surface of the sidewall 26. The fill line indicator 14 can be provided in many different manners, to be described in further detail herein. The amount of water that is necessary is just enough water to rehydrate the dry food product without retaining too much residual water after heating. Thus, the amount of water indicated in the container 10 should be optimized such that just enough residual water remains after heating to mix with the cheese sauce component, but not too much to inhibit production of the browning and dual texture attributes. The amount of water needed to hydrate the pasta can depend upon the amount of dry product that is placed in the container, the length of time it is heated for in the microwave, the dry product used, and other factors. In one aspect, where about 66 grams of dry pasta noodles are provided in the container, about 170 grams of water can be added to rehydrate the noodles upon heating at a maximum power setting in the microwave for about 4 minutes. In general, a first heating step can be provided anywhere from 1 minute to 10 minutes, but more or less time can also be provided depending on multiple factors, some of which may be the pasta size, the thickness of the pasta walls, the volume and weight of the pasta, and so on. In another aspect, the first time period for rehydrating the dehydrated product can be from 3 minutes to 6 minutes.

The amount of residual water remaining in the container 10 after heating can also be a factor of both the amount of water initially added to the container 10 as well as the amount of time the water and pasta are heated together inside the microwave. In one aspect, the water and pasta can be heated in the microwave for four minutes at an energy level between about 800 watts to about 1300 watts, however, the noodles can be heated more or less depending upon the amount of water initially added to the container, the energy level of the microwave, the amount of pasta in the container, the amount of residual water desired to be present after heating is completed, as well as other relevant factors. In general, it is desirable to microwave the pasta and water until the pasta is at least partially hydrated and the majority of the free water is absorbed.

After the pasta 18 has been rehydrated, the container 10 is removed from the microwave and an additional food component 24 that responds to heat by browning is added to the container 10. The additional food component 24 can be packaged in a separate pouch or package 20 that is removed from the container 10 prior to hydrating the pasta and added later. The additional food component can be a sauce or other similar type of food component, such as a cheese sauce, whether in powder or thickened sauce form. After the cheese sauce 24 is added to the hydrated pasta and residual water, if any, it is mixed together and can form a generally homogeneous food product that has a generally even distribution or mix of sauce in the hydrated pasta. The generally homogeneous food product is then placed back into the microwave for a second heating step. It is during the second heating step that the browning and texture change is most evident.

In the instance of the added food component, it is the cheese sauce 24 that can initiate the browning upon heating and, more specifically, it can be at least one component of the cheese sauce. The combination of the cheese sauce 24 or a component of the cheese sauce together with the heating step produce the browning and/ or dual texture of the product. In one aspect, it can be the presence of sugars and/or proteins in the cheese sauce that promote the browning effect. The amount of time required to cook the pasta and cheese sauce during the second heating step depends on many factors, some of which include the amount of product in the container, placement of susceptor, the starting temperature of the food, the moisture of the food, the ingredients of the cheese sauce or other food component added and how they respond to browning, how crispy or brown of a final product is desired, and so forth.

Thus, in one aspect, the second heating step can be provided for 45 seconds, however, more or less time can be provided. In general, a heating step anywhere from 10 seconds to 4 minutes can be provided as the second heating step, but more or less time can also be provided dependent upon the many factors already identified and what final result is desired in the product. In one aspect, the second time period for heating can be from 20 seconds to 2 minutes. The longer the cheese sauce and pasta is cooked during the second heating step the more there is a possibility for some of the flavor in the sauce to be lost or altered. Thus, an ideal heating time would be such that the amount of browning and/or texture change is balanced with the flavor result that is also desired. In another aspect, a heating time of 1 minute is used.

Optionally, a seasoning mix or other food components can be added to the dry pasta component either before or after heating and rehydrating during the first microwave step. Such seasoning or other food components can comprise potato flakes, an anti-foaming agent or an anti-boil-over composition, flavorings, or other foods such as broccoli, bacon pieces, other vegetables, cheese, meat, and so forth. Where the seasoning mix is added to the water and dry pasta prior to heating the first time, the seasoning mix can comprise an anti-foaming agent. An example of an anti-foaming agent that can be used with the food herein is described in U.S. Patent Publication No. 2006/0121168, incorporated herein by reference in its entirety. However, any other appropriate anti-foaming or anti-boil-over composition can be used.

Another option is after the product has been cooked twice and the browning and dual texture processes have been achieved, a topping can be added to the top surface of the cooked food product. The topping component can be packaged in a separate package or pouch and later opened and added to the top surface of the final product. Alternatively, the topping component can also be added to the product after it has been cooked the first time to hydrate the pasta but before the second heating step. Where the topping is added after hydration of the pasta but before the second heating step, the topping can be added after the sauce has been added and mixed with the pasta component so that the topping can sit on an upper surface of the pasta-sauce mixture. The topping can comprise one or more farinaceous food products, such as bread crumbs, potatoes, cheese, or other similar foods, as well as a browning agent, such as Maillose, that is receptive to browning. In one aspect, the topping component can comprise about 82% starch and about 12% of a browning agent, such as Maillose, however, any other amounts can be supplied that are appropriate for the multi-texture food product.

One method of optimizing the correct amount of water to add to the dry, dehydrated food product in order to rehydrate it, is to provide a fill level indicator 14 on the sidewall 26 of the container 10. A fill level or line indicator 14 can be included on the interior of the package sidewall 26 to indicate the upper level of water addition to the package containing the dehydrated food. Typical methods of making a fill line indicator 14 in a package 10 can include embossing or engraving the line, or providing a geometric feature in the package, such as an indentation or step in the sidewall 26, which indicates the fill line location. Where these methods prove difficult to see or may not form well in non-polymer materials, it may be preferable to use the susceptor and/or shield pattern to create the fill line indicator feature.

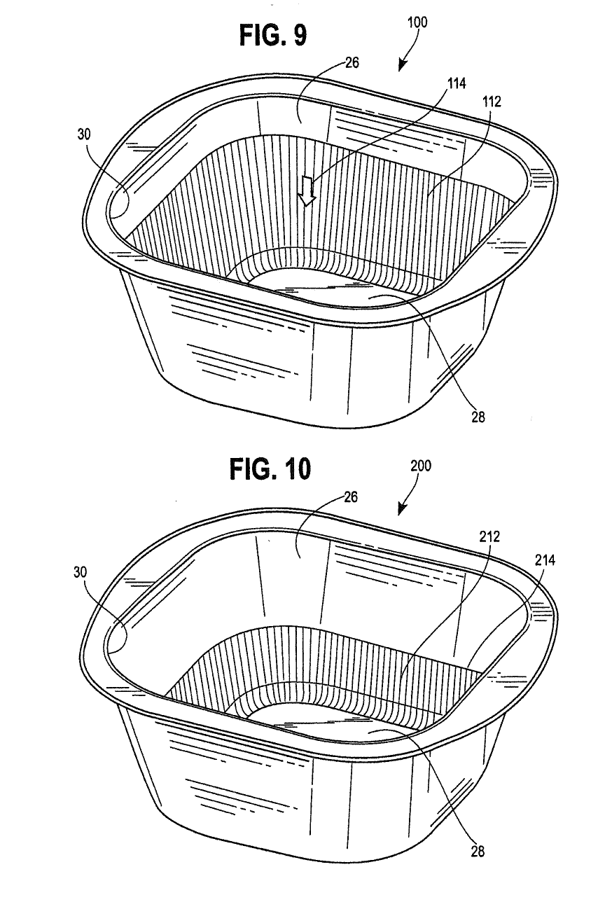

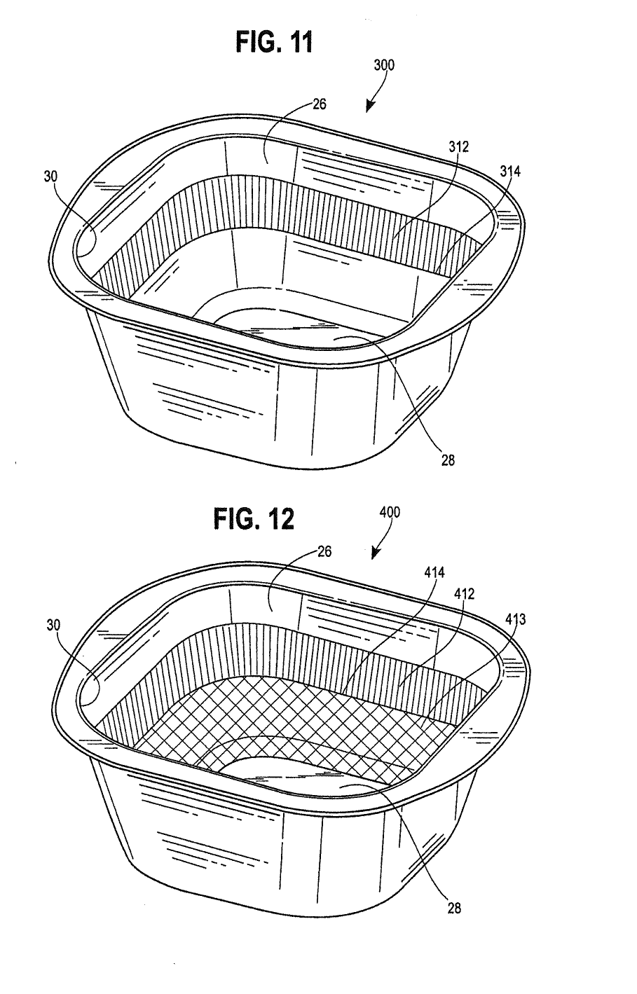

In one aspect, the fill line 414 can be provided at the transition between a full coverage susceptor 412 and a patterned susceptor 413 such that the fill line 414 can be indicated by the intersection of the two visually different regions, as in FIG. 12, or any other similar variation of materials that provide a line at an intersection of contrasting materials. Similarly, a fill line 214 or 314 can be indicated by the intersection of the susceptor material 212 or 312, respectively, with the sidewall portion that is free of susceptor material, as in FIGS. 10 and 11. In another aspect, an image can be created, such as an arrow or a line, for example, by providing susceptor material in the desired shape in an area which is free of susceptor coverage, or has partial coverage, to indicate the fill level indicator. Alternatively, an image or a line can be created using no susceptor in an area which has full susceptor coverage 112, or a patterned susceptor, such as by removing a portion of the susceptor area to create a fill level indicator 114, such as an arrow, as in FIG. 9. Thus, the absence of susceptor material in a region provided with a susceptor creates the fill level indication. In this aspect, the susceptor can have a gray colored appearance while the container can have a white-colored appearance such that the absence of the susceptor material can be indicated by a white-colored fill line indicator.

Optionally, in addition to the susceptor areas, shielded regions can also be included. The shielded regions block the microwave energy to those regions containing the shield material. An example of a shielded material can be a foil material, however any other typical shield materials appropriate for the process can be used. In one aspect, the shield may be used to ensure that a more creamy and liquid product consistency is maintained throughout the bottom and center of the product by placing the shield at least partially in the bottom section or base 28 of the container 10. By placing the shield in at least a portion of the base ensures that fewer microwave energy reaches the product in that region and that the overall product temperature and amount of moisture evaporated from the product in that region is minimized.

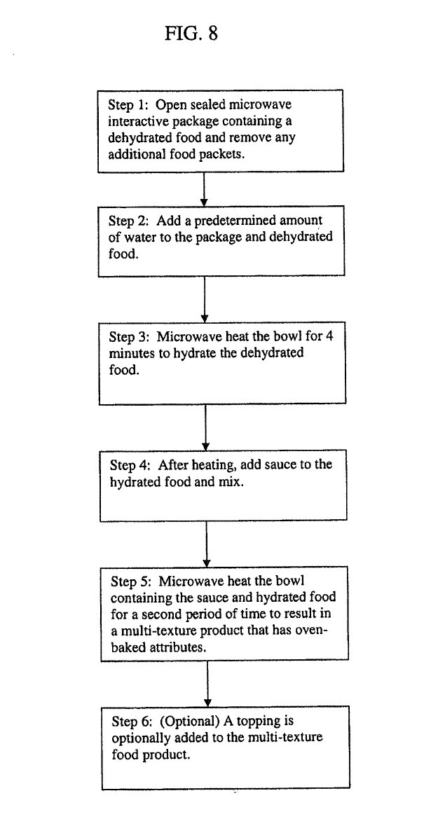

Referring to FIG. 8, a flow chart is indicated that represents one aspect of the method of preparing a shelf stable pasta and sauce product using the microwave interactive packaging. At Step 1, the package is opened. The package 10 can contain a film 16 that is sealed over the opening 30 to close the package 10 and can be removed by pulling it off, away from the opening 30. Optionally, a lid can also be provided. Once the package 10 is opened, any pouches of additional food components, such as a sauce packet, seasoning packet, and/or a topping packet can be removed from the interior 36 of the container 10 while the dry pasta noodles remain behind in the container 10.

At step 2, water 22 is added to the pasta 18 inside of the microwave interactive container 10, adding the water 22 up to the fill line indicator 14. Once the water 22 is added, the container 10 is placed in the microwave 32 and heated for about 4 minutes, as indicated in step 3. As previously stated herein, any other appropriate time can be used for heating of the water and pasta such that the pasta is at least partially hydrated.

After heating, the container 10 is removed and the sauce packet 20 is opened and added to the hydrated pasta noodles and mixed, at step 4. After combining the ingredients, the container 10 is placed in the microwave 32 for a second heating step, at step 5, where the container 10 is heated for anywhere between 20 seconds to 2 minutes, depending upon the amount of browning and texture change desired. Optionally, a lid may be placed upon the container 10 during the heating step. At step 6, the container 10 is removed from the microwave 32 and an optional topping can be added to the top surface 34 of the final product. Alternatively, the optional topping can also be added after step 4, i.e., after the cheese sauce is added and mixed, where the optional topping can be added to the top surface of the cheese-pasta mixture. The completed product has oven-baked attributes that resemble an oven-baked product and the final product can then be consumed. In the case where the sauce added comprises a cheese sauce, the final product can be a macaroni and cheese product, however, other pasta and cheese products are possible.

The outer layer of the container can comprise a material of construction that includes paperboard or other paper-based materials. In one aspect, the outer layer of the container can comprise a substrate that is stable at high temperatures that result from microwave cooking a susceptor material adjacent the outer layer. Upon formation of the final container, the container can result in a rigid or semi-rigid container. The terms “rigid” and “semi-rigid” are used herein to indicate that the structures made have the ability to generally retain their respective shapes during normal handling.

The inner layer of the container can comprise a film or laminate layer that is placed over the susceptor material, the inner layer comprising an oriented polymer film, such as a polyethylene terephthalate. Finally, the susceptor layer that is positioned between the inner and outer layers can comprise a thin layer of conductive material such as an aluminum deposit layer.

The shape of the container can be any appropriate shape for microwave cooking food components and, in particular, should be sized appropriately such that it fits inside of a standard sized microwave oven. In one aspect, the shape of the container can comprise generally a square, a circle, a rectangle, or any other appropriate shape. In another aspect, a non-cylindrical shape is preferred. This is because in a non-cylindrical shape there are differences in the distance from the center to the outer periphery. The increased distance of some areas from the center can contribute to different textures of the food product, i.e., drier at edges further from the center as compared to edges closer to the center due to differing penetration of microwave energy.

The initially packaged food components can be placed in the container and sealed with a film to cover the opening and/or a lid to cover the opening or to cover the film. Optionally, a sleeve or other wraparound film can be placed around the container. In one aspect, a paperboard sleeve is wrapped around the sealed container and can provide a stand-up feature to the sealed package.

The microwave interactive container can be used with any shelf-stable food product that is packaged in a dehydrated state for which an oven-baked appearance is desirable and which is subsequently hydrated by adding water and heating in a microwave. For instance, the final food product can be a macaroni and cheese meal, an au gratin potato or other type of potato meal, a bread stuffing mix, and the like. The microwave interactive container can be used with any two-part process for preparation of a shelf-stable dry food component where the first step requires hydrating the dry food with water and heat and the second step comprises adding a sauce or second food component that aids in browning the product upon heating in a microwave and while contained in a package having a susceptor. In one aspect, examples of dry, dehydrated products can include pasta, dried or dehydrated potato slices, dried bread crumbs, and any other food that can be rehydrated by addition of water and heating in a microwave. In another aspect, the dehydrated food can include a starch-based food product. It should be understood that wherever a pasta product is mentioned that this can similarly refer to any dehydrated product for which this two-step heating process is appropriate. In one aspect, an overall formulation can include about 50% pasta (or other dehydrated food), about 5% seasoning, which can be added together with the water or after hydration, about 40% cheese sauce, and about 5% topping, which can also be added before or after the last heating step.

The sauce or second food component added to the rehydrated food product can comprise any type of sauce such as a cheese sauce, or other dairy-based sauces, a tomato-based sauce such as a marinara sauce or other similar sauce, an oil-based sauce such as a pesto sauce or other similar sauce, and the like. The sauce component can contain an ingredient or component that aids the browning of the food upon exposure to heat from a microwave. Browning can be attributed to the sugars and proteins that are present in the cheese sauce, such browning can occur along the edge of the susceptor material when the sugars and proteins undergo a heat induced Maillard reaction. Additionally, the heat generated by the susceptor can evaporate the water from the edges causing a slight browning.

### EXAMPLES

### Comparative Example 1

This example illustrates the preparation of a pasta and sauce food product from a dehydrated shelf-stable pasta in a standard plastic polypropylene bowl without any type of susceptor material or shielding present. Dehydrated pasta was placed in the polypropylene bowl in the amount of about 33 g, to which about 124 g of water was added along with about 3.2 g of anti-foam and the bowl was placed in a microwave oven to cook. The microwave oven power was set at 1100 watts and the dehydrated pasta and water mixture was cooked for 3 minutes and 30 seconds, which was until the pasta was hydrated. After the first heating step in the microwave, the hydrated pasta was mixed with about 31.5 g cheese sauce to obtain a generally homogenous pasta and sauce mixture, and then was returned to the microwave at the same energy setting to cook for an additional 1 minute and 30 seconds. The total cook time was five minutes.

After heating the product for the second time, the pasta and sauce exhibited a minute amount of browning evident in the cheese sauce that had climbed up the sidewall of the bowl. The bottom of the product was dried with most of the cheese residing in the top quadrant of the product. From the resulting product, it can be seen that additional cook time in a standard package does not convey sufficient oven baked attributes.

### Comparative Example 2

This example illustrates the preparation of a pasta and sauce food product from a dehydrated shelf-stable pasta in a paperboard bowl having a full coverage susceptor. Dehydrated pasta was placed in the paperboard bowl with full coverage susceptor in the amount of about 33 g, to which about 124 g of water was added along with about 3.2 g of anti-foam and the bowl was placed in a microwave oven to cook. The microwave oven power was set at 1100 watts and the dehydrated pasta and water mixture was cooked for 3 minutes and 30 seconds, which was until the pasta was hydrated. After the first heating step in the microwave, the hydrated pasta was mixed with about 31.5 g cheese sauce to obtain a generally homogenous pasta and sauce mixture, and then was returned to the microwave at the same energy setting to cook for an additional 1 minute and 30 seconds. The product and bowl was removed from the microwave oven and observed, then was returned to the microwave oven and cooked for an additional minute. The total cook time was six minutes.

After the first heating step in the microwave where the pasta was cooked with water, pasta was observed to stick to the bottom wall of the bowl while some sections of the pasta were slightly undercooked and not sufficiently hydrated. After the second heating step for 1 minute and 30 seconds following the addition of the cheese sauce, there was a little edge browning and drying observed with some dark brown areas as well as some pasta stuck to the sidewall of the bowl, however, the center of the pasta and sauce mixture still maintained moisture and was creamy. After the third heating step for an additional minute, the pasta and cheese product is overcooked and appears burnt in some locations along the side edges. Along the top surface of the pasta and cheese sauce mixture a skin has formed that is dry with too much browning and drying along the edges. The center of the mixture is less saucy and not as creamy.

The drying and browning observed along with a browned aroma is desirable, however, the pasta sticking to the bottom wall and sidewalls is not desirable as well as the long cook time.

### Comparative Example 3

This example illustrates the preparation of a pasta and sauce food product from a dehydrated shelf-stable pasta in a paperboard bowl having a susceptor along the entire sidewall of the bowl, while the bottom wall is free of susceptor material. Dehydrated pasta was placed in the paperboard bowl with the susceptor in the sidewall in the amount of about 33 g, to which about 124 g of water was added along with about 3.2 g of anti-foam and the bowl was placed in a microwave oven to cook. The microwave oven power was set at 1100 watts and the dehydrated pasta and water mixture was cooked for 3 minutes and 30 seconds, which was until the pasta was hydrated. After the first heating step in the microwave, the hydrated pasta was mixed with about 31.5 g cheese sauce to obtain a generally homogenous pasta and sauce mixture, and then was returned to the microwave at the same energy setting to cook for an additional 1 minute and 30 seconds. The product and bowl was removed from the microwave oven and observed, then was returned to the microwave oven and cooked for an additional minute. The total cook time was six minutes.

After the first heating step in the microwave where the pasta was cooked with water, the pasta did not stick to the bottom wall of the bowl. After the second heating step for 1 minute and 30 seconds following the addition of the cheese sauce, there was light browning observed along the side edges of the pasta and sauce mixture with a small amount of skin formation at the top surface of the pasta and sauce mixture. There was still no pasta stuck to the bottom wall and the pasta and sauce mixture did not appear to be overdried. The center of the pasta and sauce mixture still maintained moisture and was creamy. After the third heating step for an additional minute, more browning is observed, however, some areas of the side edges of the pasta and cheese product are dried and overcooked. Product is still not stuck to the bottom wall of the bowl. Compared to the previous bowl tested in Comparative Example 2 having the full bottom susceptor, the pasta and cheese product of this example is less dried out and maintains more creamy sauce in the center and bottom of the product than in Comparative Example 2.

### Example 4

This example illustrates the preparation of a pasta and sauce food product from a dehydrated shelf-stable pasta in a paperboard bowl having a susceptor along only a portion of the sidewall of the bowl, while the bottom wall and upper portion of the sidewall are both free of susceptor material. Dehydrated pasta was placed in the paperboard bowl with the susceptor in a portion of the sidewall in the amount of about 33 g, to which about 124 g of water was added along with about 3.2 g of anti-foam and the bowl was placed in a microwave oven to cook. The microwave oven power was set at 1100 watts and the dehydrated pasta and water mixture was cooked for 3 minutes and 30 seconds, which was until the pasta was hydrated. After the first heating step in the microwave, the hydrated pasta was mixed with about 31.5 g cheese sauce to obtain a generally homogenous pasta and sauce mixture, and then was returned to the microwave at the same energy setting to cook for an additional 1 minute and 30 seconds. The total cook time was five minutes.

After the first heating step in the microwave where the pasta was cooked with water, the pasta did not stick to the bottom wall of the bowl. After the second heating step for 1 minute and 30 seconds following the addition of the cheese sauce, there was light to dark browning observed along the side edges of the pasta and sauce mixture along the sidewall of the bowl with a visible dried skin formed at the side edges of the pasta and sauce mixture. There was still no pasta stuck to the bottom wall. Compared to the previous bowl tested in Comparative Example 2 having the full coverage susceptor, there is not any browning above the product in this example where the susceptor is not present, such as where pasta and/or sauce may have become stuck to the sidewall above the top surface of the product. This provides for a less burnt or overcooked look to the food product. Thus, a favorable result was achieved with Example 4, where a browning effect resulted comprising a color change along the edges and top of the product as well as a drier texture along the outer surface of the product while maintaining the proper balance of moisture and creaminess inside of the product and at the bottom surface of the product.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method of preparing a multi-texture food product with sauce using a dehydrated, shelf-stable food, the method comprising:
adding a predetermined amount of water to a microwave interactive bowl having a microwave absorbing region and containing a dry, dehydrated shelf-stable food;
microwave heating the water and the dehydrated, shelf-stable food while in the microwave interactive bowl for a first period of time in a microwave oven to at least partially hydrate the dehydrated, shelf-stable food;
adding a sauce component to the bowl containing the at least partially hydrated food and mixing to form a generally homogeneous food product with sauce; and
microwave heating the generally homogenous food product with sauce while in the bowl for a second period of time in the microwave oven to cause the sauce component to interact with the microwave absorbing region to at least partially change the color and texture of the generally homogenous food product to the final multi-texture food product with sauce.

2. The method according to claim 1, wherein the microwave absorbing region is a susceptor material provided along a portion of a sidewall of the bowl.

3. The method according to claim 2, wherein the majority of a bottom wall of the bowl is free of the susceptor.

4. The method according to claim 2, wherein the susceptor of the sidewall is spaced from an opening of the bowl.

5. The method according to claim 1, further comprising heating the water in a microwave between 1 minute and 6 minutes to rehydrate the dehydrated, shelf-stable food.

6. The method according to claim 1, further comprising heating the generally homogenous food product in the microwave between 10 seconds and 2 minutes to result in a texture and color change of the product.

7. The method according to claim 1, further comprising filling the microwave interactive bowl with water until the water reaches an indicator along at least a portion of an interior surface of a sidewall of the bowl that indicates the predetermined amount of water.

8. The method according to claim 7, wherein the indicator is designated by either a presence of a portion of the microwave absorbing region or by an absence of the microwave absorbing region.

9. The method according to claim 1, wherein the microwave interactive bowl includes a shielded region.

10. The method according to claim 1, further comprising adding a topping food to either the generally homogenous food product or to the final multi-texture food product.

11. The method according to claim 1, wherein the dehydrated, shelf-stable food is a pasta or other similar farinaceous food.

12. The method according to claim 1, wherein the sauce is selected from the group consisting of cheese sauce, a dairy-based sauce, a tomato-based sauce and an oil-based sauce.

13. The method according to claim 1, wherein the sauce contains sugars and proteins that interact with the microwave absorbing region upon microwave heating to result in the at least partial change in color and texture.

14. The method according to claim 1, wherein the bowl is non-cylindrical in shape so that the generally homogenous food product dries out faster at corners of the bowl compared to at straight edges of the bowl.

15. A product kit for preparing a multi-texture food product and sauce using a dehydrated, shelf-stable food, the kit comprising:
a microwave interactive, paperboard bowl having a susceptor material provided at least partially along a sidewall of the bowl;
a dehydrated, shelf-stable food contained within the microwave interactive bowl; and
a segregated sauce component packaged together with the microwave interactive bowl for later addition to the shelf-stable food after rehydration.

16. The product kit of claim 15, wherein the microwave interactive bowl has a fill level indicator along the sidewall to indicate an upper level of water addition.

17. The product kit of claim 15, wherein the microwave interactive bowl has a majority of a bottom wall free of susceptor material.

18. The product kit of claim 15, wherein the fill level indicator is designated by either a presence of a portion of the susceptor material or by an absence of the susceptor material in the sidewall of the bowl.
